(19) United States
(12) Patent Application Publication
(10) Pub. No.: US 2006/0112127 A1
(43) Pub. Date: May 25, 2006

(54) Method for efficiently mapping error messages to unique identifiers

(75) Inventors: Michael Krause, Redmond, WA (US); Alok Karnik, Kirkland, WA (US); Corneliu Lupu, Sammamish, WA (US); Stefan F. Sierakowski, Duvall, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: Microsoft Corporation, Redmond, WA (US)

(21) Appl. No.: 10/994,307

(22) Filed: Nov. 23, 2004

(51) Int. Cl. G06F 17/00

(52) U.S. Cl. 707/102

(57) ABSTRACT

A method and computer product for mapping an error message to an identifier to enable error reporting is provided. An error message hash vector is associated with a resource ID and a resource module. When an error message is displayed, substrings of text in the message are hashed and matched to a corresponding hash vector. The substrings are defined as text that is between the start of the message and wildcard string (a string that is dynamically inserted at runtime), between a wildcard string and the end of the message, or between two wildcard strings. Based on the hash of these substrings, error messages can be quickly and efficiently mapped to a corresponding resource ID and module, which can then be reported.

### FIELD OF THE INVENTION

This invention pertains generally to the field of computer error reporting and more particularly to a mechanism for efficiently matching computer error messages to a well-formed identifier.

### BACKGROUND OF THE INVENTION

In maintaining and upgrading software, it is advantageous for a software designer/manufacturer to receive notification of error messages displayed to the user of the manufacturer's software. If such reporting is not built into the software at the time of the design, it is very difficult to retroactively provide error reporting ability in the software. In order to achieve successful error reporting, a message ID is needed for each message to uniquely identify that message. If a message ID is not available, the raw message text must be reported, since the same message can have different inserted text. For example, “Cannot find ‘foo’” and “Cannot find ‘bar’” are different pieces of text but are really the same message. Also, the raw message text is language-dependent, which would unnecessarily separate reports between languages. Uploading the raw text also presents a severe privacy issue.

An alternative would be to modify the software's source code so that each instance where a message is displayed to the user, a known identifier for that message would be reported. This is problematic for many reasons. For example, the number of error messages in the Microsoft Windows® Operating System (OS) are estimated at somewhere between 40,000 and 100,000. The amount of time required to change all error messages in the code, test all changes for regression, get localization to work with the new system, etc., is extremely prohibitive.

Accordingly, there is a need in the software arts to provide a method for retroactively provisioning error reporting capability in software, thus improving the software in subsequent releases and allowing designers to better create patches for non-fatal errors.

### BRIEF SUMMARY OF THE INVENTION

In view of the foregoing, one embodiment of the present invention provides a method for creating an error message hash table for reporting error messages in a computer application to an interested party, comprising loading a string resource, constructing a message hash vector for the string resource, and storing the hash vector in a hash vector table along with a resource ID for the string resource. The method may further include storing a resource module name for the string resource with the hash vector in the hash vector table. In one embodiment, the hash vector includes a hash of a string and length of that string.

If a string of the string resource contains wildcard characters, constructing a message hash vector may further comprise determining a number of substrings in a string of the string resource, wherein a substring is a section of the string that is adjacent to a wildcard character at one end and one of the beginning of the message, the end of the message, and another wildcard character at the other end; generating a hash for every substring; determining a length for every substring; and storing a hash, length, and resource ID for every substring in the hash vector. A wildcard character is a character dynamically inserted into a message box that uses the string resource. A resource module name associated with the string resource may be stored with every substring hash, length, and resource ID in the hash vector. If a string of the string resource does not contain wildcard characters, constructing a message hash vector may further comprises generating a hash for the string, determining a length for the string, and storing the hash, length, and a resource ID for the string in the hash vector.

Another embodiment of the invention provides a method for providing error message reporting for reporting error messages in a computer application to an interested party, comprising detecting that an error message is displayed and matching a hash of the error message text to a hash vector in a hash vector table, wherein a resource ID associated with the error message is stored with the hash vector in the hash vector table. The method may further comprise reporting the resource ID to the interested party. A resource module name associated with the error message may also be stored in the hash vector.

Matching a hash of the error message to a hash vector may further comprise: determining whether a substring of the error message matches a substring hash contained in a hash vector; if the substring matches and there are more substring hashes in the hash vector, determining whether a next substring of the error message matches a next substring hash; and if a substring of the error message does not match a substring hash, determining that the error message does not match the hash vector.

Additional features and advantages of the invention are made apparent from the following detailed description of illustrative embodiments that proceeds with reference to the accompanying figures.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1A is a schematic generally illustrating an exemplary network environment across which the present invention operates.

FIG. 1B is a block diagram generally illustrating an exemplary computer system on which the present invention resides;

FIG. 2A is an exemplary string resource;

FIG. 2B is an exemplary dialog box using the string resource of FIG. 2A;

FIG. 3 is a flow diagram illustrating a method for providing error message hashing in accordance with the present invention;

FIG. 4 is a flow diagram detailing a method for creating a hash vector table for a resource; and

FIG. 5 is a flow diagram detailing a method for matching a message text to a corresponding hash vector.

### DETAILED DESCRIPTION OF THE INVENTION

Turning to the drawings, wherein like reference numerals refer to like elements, the present invention is illustrated as being implemented in a suitable computing environment. The following description is based on embodiments of the invention and should not be taken as limiting the invention with regard to alternative embodiments that are not explicitly described herein.

In the description that follows, the present invention is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the device in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that the various acts and operations described hereinafter may also be implemented in hardware.

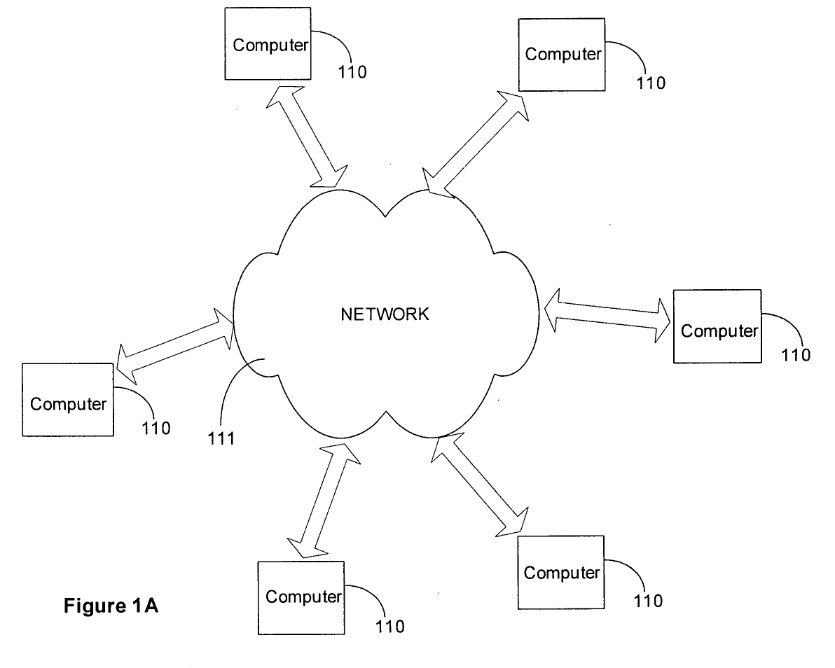

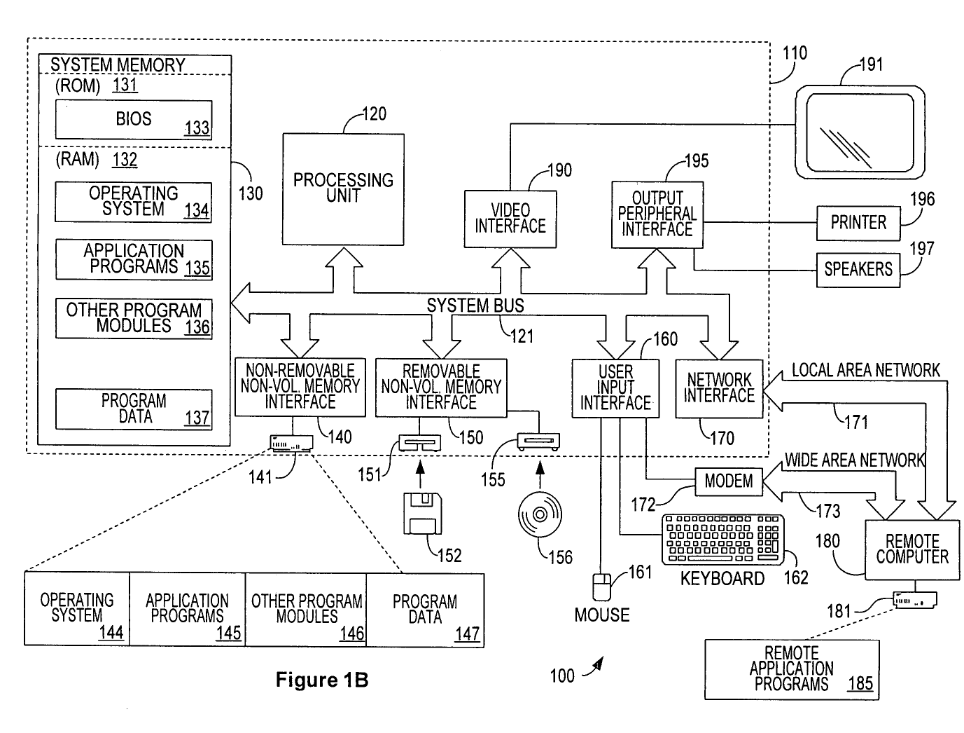

An example of a networked environment in which the invention may be used will now be described with reference to FIG. 1A. The example network includes several computers 110 communicating with one another over a network 111, represented by a cloud. Network 111 may include many well-known components, such as routers, gateways, hubs, etc. and allows the computers 110 to communicate via wired and/or wireless media. When interacting with one another over the network 111, one or more of the computers may act as clients, network servers, or peers with respect to other computers. Accordingly, the various embodiments of the invention may be practiced on clients, network servers, peers, or combinations thereof, even though specific examples contained herein do not refer to all of these types of computers.

FIG. 1B illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary computing environment 100.

The invention is operational with numerous other general-purpose or special-purpose computing system environments or configurations. Examples of well known computing systems, environments, and configurations that may be suitable for use with the invention include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer-storage media including memory-storage devices.

With reference to FIG. 1B, an exemplary system for implementing the invention includes a general-purpose computing device in the form of a computer 110, which may act as a client, network server, quarantine server, or peer within the context of the invention. Components of the computer 110 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture bus, Micro Channel Architecture bus, Enhanced ISA bus, Video Electronics Standards Associate local bus, and Peripheral Component Interconnect bus, also known as Mezzanine bus.

The computer 110 typically includes a variety of computer-readable media. Computer-readable media can be any available media that can be accessed by the computer 110 and include both volatile and nonvolatile media, removable and non-removable media. By way of example, and not limitation, computer-readable media may include computer storage media and communication media. Computer storage media include both volatile and nonvolatile, removable and non-removable media implemented in any method or technology for the storage of information such as computer-readable instructions, data structures, program modules, or other data. Computer storage media include, but are not limited to, RAM, ROM, EEPROM, flash memory or other memory technology, CD-ROM, digital versatile disks or other optical disk storage, magnetic cassettes, magnetic tape, magnetic disk storage or other magnetic storage devices, or any other medium which can be used to store the desired information and which can be accessed by the computer 110. Communication media typically embody computer-readable instructions, data structures, program modules, or other data in a modulated data signal such as a carrier wave or other transport mechanism and include any information-delivery media. The term “modulated data signal” means a signal that has one or more of its characteristics set or changed in such a manner as to encode information in the signal. By way of example, and not limitation, communication media include wired media such as a wired network or direct-wired connection and wireless media such as acoustic, RF, infrared, and other wireless media. Combinations of the any of the above should also be included within the scope of computer-readable media.

The system memory 130 includes computer storage media in the form of volatile and nonvolatile memory such as read only memory (ROM) 131 and random access memory (RAM) 132. A basic input/output system 133 (BIOS), containing the basic routines that help to transfer information between elements within the computer 110, such as during start-up, is typically stored in ROM 131. RAM 132 typically contains data and program modules that are immediately accessible to or presently being operated on by the processing unit 120. By way of example, and not limitation, FIG. 1B illustrates an operating system 134, application programs 135, other program modules 136, and program data 137.

The computer 110 may also include other removable/non-removable, volatile/nonvolatile computer storage media. By way of example only, FIG. 1B illustrates a hard disk drive 141 that reads from or writes to non-removable, nonvolatile, magnetic media, a magnetic disk drive 151 that reads from or writes to a removable, nonvolatile, magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary computing environment 100 include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as the interface 140, and the magnetic disk drive 151 and the optical disk drive 155 are typically connected to the system bus 121 by a removable memory interface, such as the interface 150.

The drives and their associated computer storage media discussed above and illustrated in FIG. 1B provide storage of computer-readable instructions, data structures, program modules, and other data for the computer 110. In FIG. 1B, for example, the hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers to illustrate that, at a minimum, they are different copies.

A user may enter commands and information into the computer 110 through input devices such as a keyboard 162 and a pointing device 161, commonly referred to as a mouse, trackball, or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port, or a universal serial bus. A monitor 191 or other type of display device is also connected to the system bus 121 via an interface, such as a video interface 190. In addition to the monitor 191, the computer 110 may also include other peripheral output devices such as speakers 197 and a printer 196 which may be connected through an output peripheral interface 195.

The computer 110 operates in a networked environment using logical connections to one or more remote computers, such as a remote computer 180. The remote computer 180 may be a personal computer, a server, a router, a network PC, a peer device, or other common network node and typically includes many or all of the elements described above relative to the personal computer 110 although only a memory storage device 181 has been illustrated in FIG. 1B. The logical connections depicted in FIG. 1B include a local area network (LAN) 171 and a wide area network (WAN) 173 but may also include other networks. Such networking environments are commonplace in offices, enterprise-wide computer networks, intranets, and the Internet. Furthermore, LAN 171 includes both wired and wireless connections.

When used in a LAN networking environment, the personal computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the personal computer 110, or portions thereof, may be stored in the remote memory storage device 181. By way of example, and not limitation, FIG. 1B illustrates the remote application programs 185 as residing on the memory device 181. It will be appreciated that the network connections shown are exemplary, and other means of establishing a communications link between the computers may be used.

In a typical scenario where the invention is practiced, error messages that are displayed to users are reported to an interested party such a software designer or manufacturer. The software may be executing on a personal computer such as computer 110, and communicated to a remote computer 180 of the interested party over the WAN 173. To report these errors a method for mapping error messages to an identifier is used. An error message hash vector is associated with a resource ID and a resource module. When an error message is displayed, substrings of text in the message are hashed and matched to a corresponding hash vector. The substrings are defined as text that is between the start of the message and wildcard string (a string that is dynamically inserted at runtime), between a wildcard string and the end of the message, or between two wildcard strings. Based on the hash of these substrings, error messages can be quickly and efficiently mapped to a corresponding resource ID and module, which can then be reported to an interested party.

In one embodiment of the invention, message mapping works through callouts to the LoadString and MessageBox classes of API's in the Windows OS. When a string resource is loaded, it is converted to a message hash vector which is associated with the resource identifier and the resource module, and then cached per process in a hash vector table. When the message is displayed through MessageBox, it is quickly matched to the corresponding message hash vector in the cache and the corresponding identifier is extracted and used for reporting. This message mapping scheme is fast and requires little memory.

In this embodiment of the invention, message mapping is implemented in a static library, WinMsgRepCore.lib. This library is linked into USER32.DLL, which provides the LoadString and MessageBox API's. WinMsgRepCore.lib provides three functions, WerpInitializeMessageMapping, WerpNotifyLoadString and WerpNotifyMessageBox, which USER32 code calls into whenever messages are loaded or displayed. LoadString calls WerpNotifyLoadString, which adds the message to the hash vector table. MessageBox calls WerpNotifyMessageBox, which uses the message text to lookup the message ID in the hash vector table.

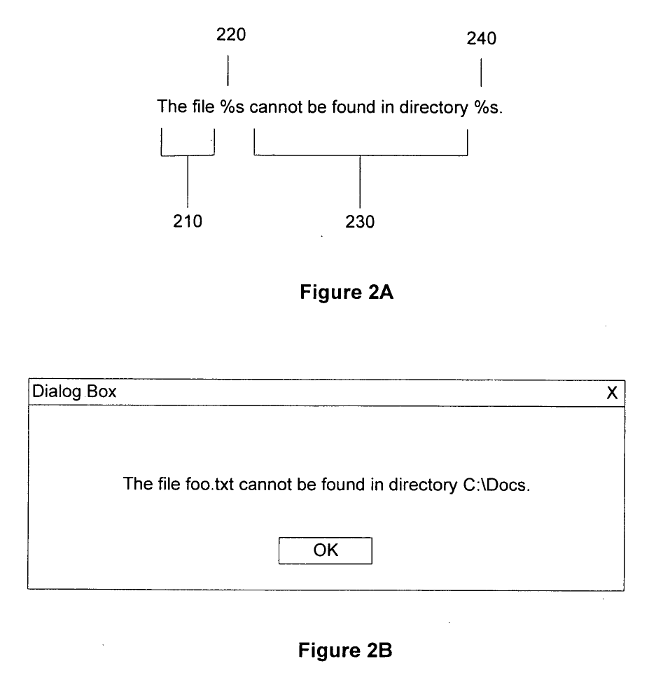

Messages may contain string inserts, i.e., text that is dynamically inserted when a message is displayed. For example, the shell may have a message string resource, “The file % s could not be found in directory % s.” Accordingly, message strings are broken up into substrings. FIG. 2A demonstrates the example message would be broken up into substring 210, “The file,” and substring 230, “could not be found in directory.” These substrings are separated by the dynamic text, referred to as wildcards. Wildcard 220 separates substrings 210 and 230, while wildcard 240 appears at the end of the message string. At runtime, wildcards are substituted with some other string. For example, FIG. 2B illustrates a dialog box the used the string resource of FIG. 2A. The substrings are converted to message hash vectors, which contain the hashes and lengths of all non-wildcard substrings.

Since the message text may contain inserted strings, it cannot be hashed as is to quickly lookup the message in the hash table. Likewise, a linear search is not desirable. Therefore, in one embodiment of the invention, the first eight characters and last eight characters of the message are hashed. However, if either the first or last eight characters of a message string is a wildcard, the hash is not valid. All valid hashes are then combined to form the hash which is used to insert into the table. If neither hash is valid, meaning the first and last part of the string contains an inserted string, the string is unmappable. Lookup is performed from within WerpNotifyMessageBox. The hash of the first and last eight characters is computed, and combined into a third hash. A lookup into the hash table is performed for each of the three hashes. Each hash table entry contains a list of message hash vectors that match the initial lookup. The message text is compared against the message hash vector. The first match is returned; if a string matches multiple hash vectors only one is returned.

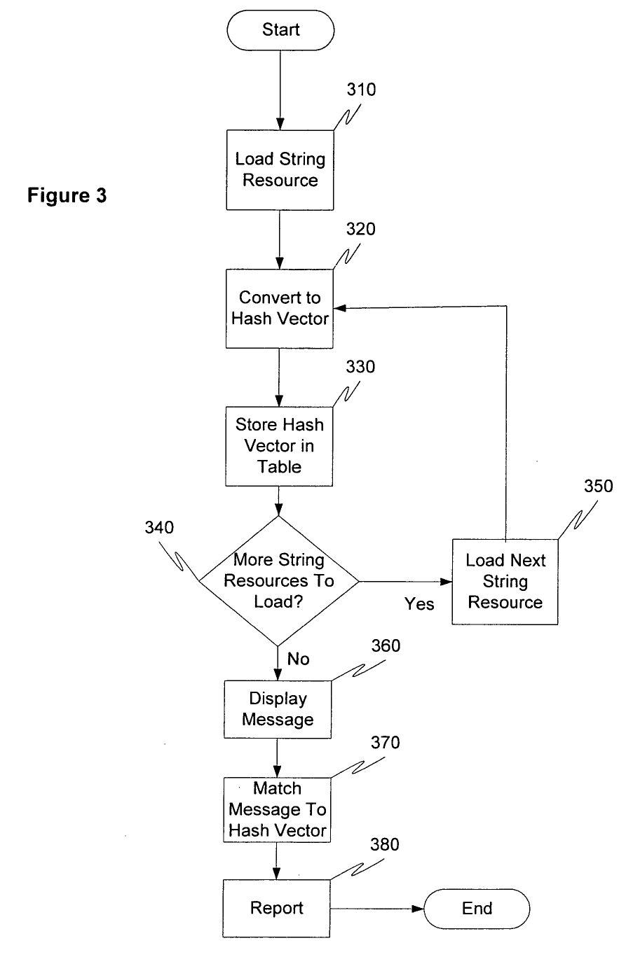

An exemplary operation of one embodiment of the invention is depicted in FIG. 3. At step 310 a string resource is loaded. The string resource is converted to a hash vector at step 320. At step 310, the hash vector is stored in a hash vector table along with the resource ID and resource module for the string resource. It is determined whether there are more string resources to load at step 340. If so, the next string resource is acquired at step 350, and the process returns to step 320. If all string resources have been converted to hash vectors and stored, the hash vector table is complete. Eventually, a message is displayed at step 360. The message text is matched to a hash vector in the hash vector table at step 370. The resource ID and resource module are then reported to the software manufacturer at step 380. In one embodiment, the report is sent via a computer network.

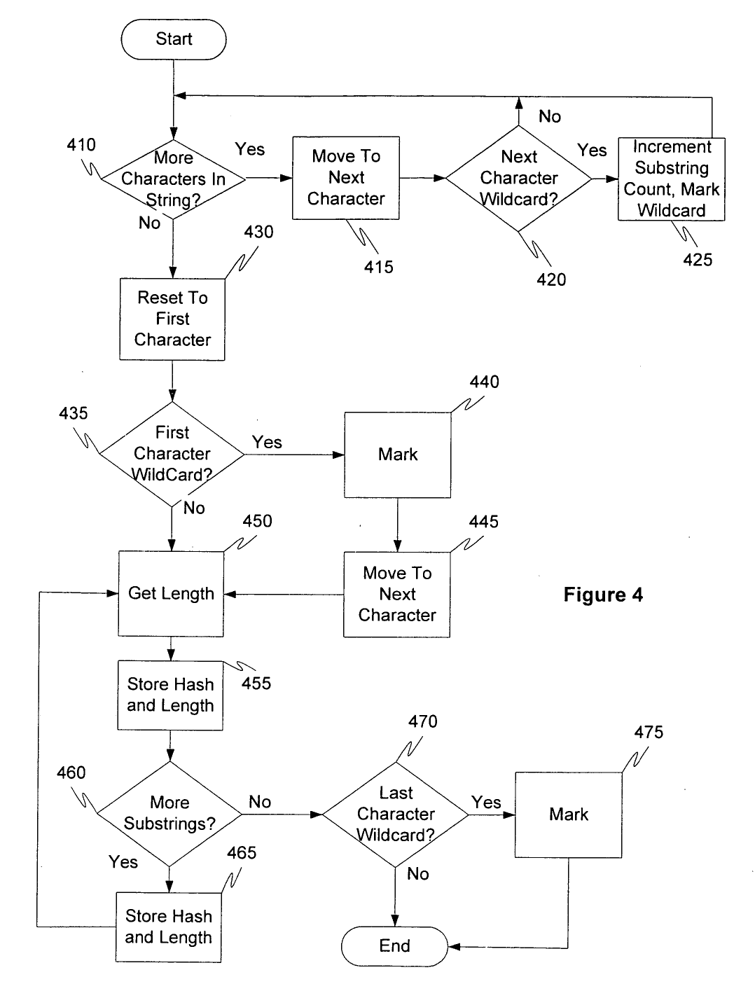

The message hash vector construction routine is described in detail with reference to FIG. 4. This routine is called from WerpNotifyLoadString, and takes as its input a message string loaded from a resource. The output is a message hash vector. At step 410, the routine determines whether there are more characters in the string. If so, analysis moves to the next character and increments a character count for a current substring at step 415. At step 420, the routine determines whether the character is a wildcard. If so, at step 425 a substring counter is incremented, the wildcard position is marked, the analysis advances past the wildcard character, and the routine returns to step 410. If the character is not a wildcard, the routine simply returns to step 410. When there are no more characters, the routine resets to the first character at step 430.

At step 435, the routine determines whether the first character is a wildcard. If so, a starting insert is marked at step 440, the routine moves to the next character at step 445, and then proceeds to step 450. If the character is not a wildcard, the routine simply proceeds to step 450. The length of the current substring is determined at step 450. At step 455, the routine hashes the substring and stores the substring hash and the length of the substring in a message hash vector. At step 460, the routine determines whether there are more substrings to process. If so, the routine moves to the next substring at step 465, and returns to step 450. If there are no more substrings, the routine determines whether the last character in the string is a wildcard at step 470. If not, the routine ends. If so, the routine marks and ending insert to signify the existence of an ending wildcard at step 475. The routine then ends.

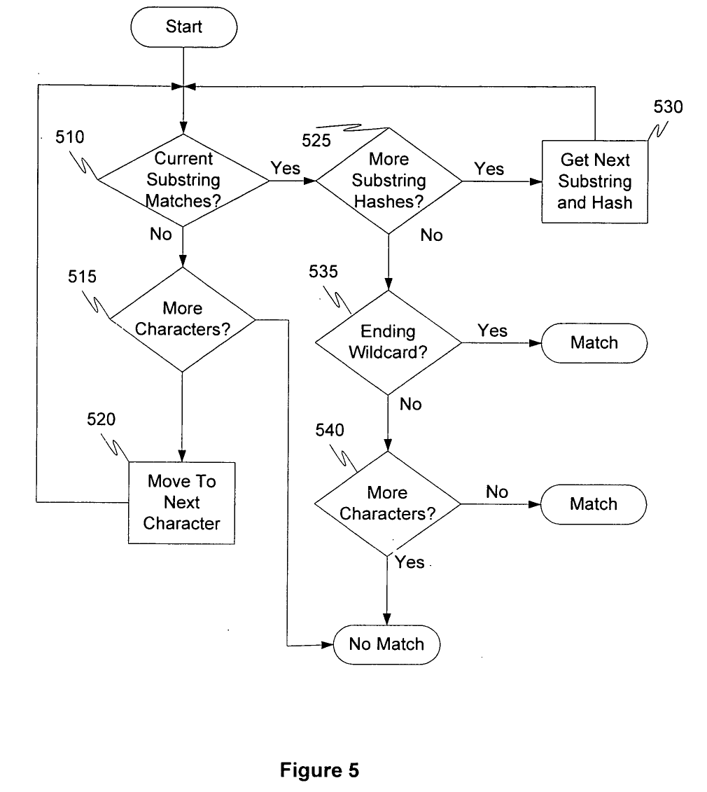

The message hash vector matching routine is described in detail with reference to FIG. 5. This routine is called from WerpNotifyMessageBox, and takes as its input a message hash vector and formatted message text about to be displayed in a message box. The output is a Boolean “true” if the message text matches the message hash vector, and “false” if the message text does not match the message hash vector. At step 510, the current substring is hashed and compared to the values of the current substring hash in the hash vector. If no match is determined, the routine determines whether there are more characters in the full substring at step 515. If there are no more characters, then the substring does not match the message hash. If there are more characters, the current substring is extended to include the next character in the full substring at step 520. The routine then returns to step 510 to repeat the comparison.

If, at step 510, the current substring does match the current message hash in the hash vector, it is determined whether there are more substring hashes in the hash vector at step 525. If so, the next substring from the message text is set as the current substring, and the next substring hash from the hash vector is set as the current substring hash, and the routine returns to step 510 for further comparison. If there are no more substring hash values in the hash vector, the routine determines if the message text ends with a wildcard at step 535. If so, then a match is determined. If message text does not end in a wildcard, it is determined whether there are more characters in the message text at step 540. If not, then a match is determined. If there are more characters, then the message text cannot match the hash vector.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for creating an error message hash table for reporting error messages in a computer application to an interested party, comprising:
loading a string resource;
constructing a message hash vector for the string resource; and
storing the hash vector in a hash vector table along with a resource ID for the string resource.

2. The method of claim 1, further comprising storing a resource module name for the string resource with the hash vector in the hash vector table.

3. The method of claim 1, wherein hash vector includes a hash of a string and length of that string.

4. The method of claim 1, wherein, if a string of the string resource contains wildcard characters, constructing a message hash vector comprises:
determining a number of substrings in a string of the string resource, wherein a substring is a section of the string that is adjacent to a wildcard character at one end and one of the beginning of the message, the end of the message, and another wildcard character at the other end;
generating a hash for every substring;
determining a length for every substring; and
storing a hash, length, and resource ID for every substring in the hash vector.

5. The method of claim 4, wherein a wildcard character is a character dynamically inserted into a message box that uses the string resource.

6. The method of claim 4, wherein a resource module name associated with the string resource is stored with every substring hash, length, and resource ID in the hash vector.

7. The method of claim 1, wherein, if a string of the string resource does not contain wildcard characters, constructing a message hash vector comprises:
generating a hash for the string;
determining a length for the string; and
storing the hash, length, and a resource ID for the string in the hash vector.

8. The method of claim 7, wherein a wildcard character is a character dynamically inserted into a message box that uses the string resource.

9. A method for providing error message reporting for reporting error messages in a computer application to an interested party, comprising:
detecting that an error message is displayed; and
matching a hash of the error message text to a hash vector in a hash vector table, wherein a resource ID associated with the error message is stored with the hash vector in the hash vector table.

10. The method of claim 9, further comprising reporting the resource ID to the interested party.

11. The method of claim 9, wherein a resource module name associated with the error message is also stored in the hash vector.

12. The method of claim 11, further comprising reporting the resource module name to the interested party.

13. The method of claim 9, wherein matching a hash of the error message to a hash vector comprises:
determining whether a substring of the error message matches a substring hash contained in a hash vector; and
if the substring matches and there are more substring hashes in the hash vector, determining whether a next substring of the error message matches a next substring hash; and
if a substring of the error message does not match a substring hash, determining that the error message does not match the hash vector.

14. A computer-readable medium having computer-executable instructions for creating an error message hash table for reporting error messages in a computer application to an interested party, the computer-executable instructions facilitating performing a set of steps comprising:
loading a string resource;
constructing a message hash vector for the string resource; and
storing the hash vector in a hash vector table along with a resource ID for the string resource.

15. The computer-readable medium of claim 14, the steps further comprising storing a resource module name for the string resource with the hash vector in the hash vector table.

16. The computer-readable medium of claim 14, wherein hash vector includes a hash of a string and length of that string.

17. The computer-readable medium of claim 14, wherein, if a string of the string resource contains wildcard characters, the constructing a message hash vector step comprises:
determining a number of substrings in a string of the string resource, wherein a substring is a section of the string that is adjacent to a wildcard character at one end and one of the beginning of the message, the end of the message, and another wildcard character at the other end;
generating a hash for every substring;
determining a length for every substring; and
storing a hash, length, and resource ID for every substring in the hash vector.

18. The computer-readable medium of claim 17, wherein a wildcard character is a character dynamically inserted into a message box that uses the string resource.

19. The computer-readable medium of claim 17, wherein a resource module name associated with the string resource is stored with every substring hash, length, and resource ID in the hash vector.

20. The computer-readable medium of claim 14, wherein, if a string of the string resource does not contain wildcard characters, the constructing a message hash vector step comprises:
generating a hash for the string;
determining a length for the string; and
storing the hash, length, and a resource ID for the string in the hash vector.

21. The computer-readable medium of claim 20, wherein a wildcard character is a character dynamically inserted into a message box that uses the string resource.

22. A computer-readable medium having computer-executable instructions for providing error message reporting for reporting error messages in a computer application to an interested party, the computer-executable instructions facilitating performing a set of steps comprising:
detecting that an error message is displayed; and
matching a hash of the error message text to a hash vector in a hash vector table, wherein a resource ID associated with the error message is stored with the hash vector in the hash vector table.

23. The computer-readable medium of claim 22, the steps further comprising reporting the resource ID to the interested party.

24. The computer-readable medium of claim 22, wherein a resource module name associated with the error message is also stored in the hash vector.

25. The computer-readable medium of claim 24, the steps further comprising reporting the resource module name to the interested party.

26. The computer-readable medium of claim 22, wherein the matching a hash of the error message to a hash vector step comprises:
determining whether a substring of the error message matches a substring hash contained in a hash vector; and
if the substring matches and there are more substring hashes in the hash vector, determining whether a next substring of the error message matches a next substring hash; and
if a substring of the error message does not match a substring hash, determining that the error message does not match the hash vector.
